(19) United States
(12) Patent Application Publication
(10) Pub. No.: US 2013/0281638 A1
(43) Pub. Date: Oct. 24, 2013

(54) TRICYCLO COMPOUND-POLYMER CONJUGATE

(71) Applicant: SUCAMPO AG, Zug (CH)

(72) Inventors: Ryuji UENO, Potomac, MD (US); Peter LICHTLEN, Thalwil (CH); Robert GURNY, Geneva (CH); Michael MOLLER, Saint Cergue (CH)

(73) Assignee: SUCAMPO AG, Zug (CH)

(21) Appl. No.: 13/866,745

(22) Filed: Apr. 19, 2013

Related U.S. Application Data
(60) Provisional application No. 61/636,186, filed on Apr. 20, 2012.

(51) Int. Cl. C08G 63/08

(52) U.S. Cl. CPC C08G 63/08
USPC 525/450

(57) ABSTRACT

A tricycle compound-polymer conjugate including a conjugate comprising a tricyclo compound and an alkyl substituted polylactide compound is provided. A pharmaceutical composition comprising the conjugate is also provided.

### CROSS-REFERENCE TO RELATED APPLICATIONS

This application claims the benefit of U.S. Provisional Application No. 61/636,186 filed Apr. 20, 2012, the disclosures of which are all hereby incorporated by reference.

### TECHNICAL FIELD

The present invention relates to a novel tricyclo compound-polymer conjugate.

### BACKGROUND ART

Biocompatible and biodegradable polylactides/glycolides (PLA/PLGA) have received high attention over the last thirty years in the biomedical field as sutures, implants, colloidal drug delivery systems (Penning et al., 1993; Uhrich et al., 1999), and more recently also in tissue repairing and engineering (Liu and Ma, 2004; Stock and Mayer, 2001) and anti-cancer drug delivery (Mu and Feng, 2003; Jiang et al., 2005). Next to the medical field they are also widely used in the packaging area. As biodegradable “green polymers” they are preferable to the commodity polymers currently used (Drumright et al., 2000; Vink et al., 2003).

There is a crucial need of well-defined polylactide-based materials with advanced properties to fit all the requirements for the different applications. For example, PLA/PLGA homo- and co-polymers synthesized by the well-established ring opening polymerization (ROP) process (Dechy-Cabaret et al., 2004; Kricheldorf et al., 1995; Schwach et al., 1997; Degee et al., 1999; Ryner et al., 2001) have a glass transition temperature (Tg) limited to a range of only 40-60° C. (Jamshidi et al., 1988; Vert et al., 1984), independent of the polymer molecular weight and chemical composition. This combined with interesting mechanical properties makes them suitable in medical applications as biodegradable implants, bone fracture fixation devices, scaffolds for living cells.

These polylactides, however, have significant limitations for drug delivery purposes. For drug delivery purposes, polylactides need to be formulated with organic solvents and administered as solutions or in form of nano- and micro-particles, and polylactides cannot be injected on their own. Thus there is a significant need for a polylactide which may be used for drug delivery that does not require the use of an organic solvent or to form nano- and micro-particles.

WO2007/012979 discloses compositions and methods relating to polylactides which may be used for drug delivery which do not require the use of an organic solvent or to form nano- and micro-particles prior to injection. These polylactides may be used, for example, to administer a drug to a subject (e.g., a human patient) parenterally without the use of a solvent. More specifically, WO2007/012979 discloses compositions and methods of preparing a pharmaceutical preparation comprising a drug and an alkyl substituted polylactide; wherein the alkyl substituted polylactide is viscous; and wherein a solvent is not required for said admixing (the cited reference is herein incorporated by reference).

WO2012/014011 discloses compositions comprising polymers prepared by melt polycondensation of one or more substituted or unsubstituted C4-C32 2-hydroxyalkyl acids, method of preparing a pharmaceutical composition comprising thereof, and a method for delivering a bioactive agent to a subject, comprising administering to the subject an effective amount of the composition therein (the cited reference is herein incorporated by reference).

Tacrolimus, tricycle compound with potent immunosuppressive activity is poorly water-soluble (Honbo et al., 1987; Kino et al., 1987; Tamura et al., 2002). In order to improve the solubility of tacrolimus, various oral formulations of tacrolimus such as an inclusion complex (Arima et al., 2001), nanoparticles (Nassar et al., 2008; Sinswat et al., 2008), a prodrug with poly(ethylene glycol) esters (Chung and Cho, 2004), liposome (Lee et al., 1995), microemulsion (Borhade et al., 2008a,b) and solid dispersion with sodium carboxylmethyl cellulose (Park et al., 2009; Yamashita et al., 2003) have been studied. The solid-dispersion system, a well-established method for increasing the solubility of poorly water-soluble drugs is proposed for tacrolimus (International Journal of Pharmaceutics 395 (2010) 161-166). Despite of various efforts, satisfied improvement in the solubility of tacrolimus has not yet been obtained.

### DISCLOSURE OF THE INVENTION

The present invention relates to a novel tricycle compound-polymer conjugate. Especially, the present invention relates to a novel conjugate comprising a tricyclo compound and an alkyl substituted polylactide compound.

In one aspect, the present invention relates to a pharmaceutical composition comprising a conjugate comprising a tricyclo compound and an alkyl substituted polylactide compound.

### BRIEF DESCRIPTION OF DRAWINGS

FIG. 1 shows efficiency of Tacrolimus incorporation into MPEG-hexPLA polymer micelles.

FIG. 2 shows actual obtained Tacrolimus formulation concentrations for the given target concentrations.

### DETAILED DESCRIPTION OF THE INVENTION

The present invention relates to a novel conjugate comprising a tricyclo compound and an alkyl substituted polylactide compound.

### 1) Conjugate

The term “conjugate” includes drug-polymer complex, drug-polymer combination, micelle formed by drug-polymer, or any other possible drug-polymer conjugate as long as the drug is incorporated, entrapped, dispersed or conjugated to the polymer matrix.

### 2) Tricyclo Compound

“tricyclo compound”, as used herein, refers to the following general formula (I) or a pharmaceutically acceptable salt thereof.

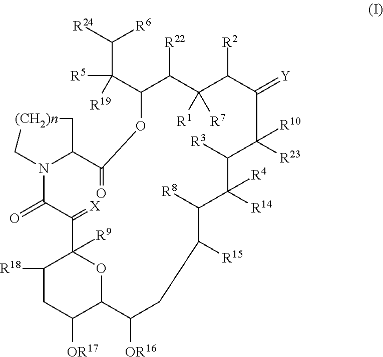

wherein adjacent pairs of R¹ and R², R³ and R⁴, and R⁵ and R⁶ each independently

a) consist of two adjacent hydrogen atoms, wherein R² is optionally alkyl, or

b) form another bond optionally between carbon atoms binding with the members of said pairs;

R⁷ is hydrogen atom, hydroxy, protected hydroxy or alkyloxy, or may form oxo with R¹;

R⁸ and R⁹ each independently show hydrogen atom or hydroxy;

R¹⁰ is hydrogen atom, alkyl, alkyl substituted by one or more hydroxy, alkenyl, alkenyl substituted by one or more hydroxy or alkyl substituted by oxo;

X is oxo, (hydrogen atom, hydroxy), (hydrogen atom, hydrogen atom), or a group of the formula —CH₂O—;

Y is oxo, (hydrogen atom, hydroxy), (hydrogen atom, hydrogen atom), or a group of the formula N—NR¹¹R¹² or N—OR¹³;

R¹¹ and R¹² each independently show hydrogen atom, alkyl, aryl or tosyl;

R¹³, R¹⁴, R¹⁵, R¹⁶, R¹⁷, R¹⁸, R¹⁹, R²² and R²³ each independently show hydrogen atom or alkyl;

R²⁴ is an optionally substituted ring that may contain one or more hetero atom(s) and;

n is 1 or 2.

In addition to the meaning noted above, Y, R¹⁰ and R²³ may show, together with the carbon atom they bind with, a saturated or unsaturated 5 or 6-membered heterocyclic group containing nitrogen atom, sulfur atom and/or oxygen atom, the heterocyclic group being optionally substituted by one or more group(s) selected from alkyl, hydroxy, alkyloxy, benzyl, a group of the formula —CH₂Se(C₆H₅), and alkyl substituted by one or more hydroxy, or its pharmaceutically acceptable salt.

In the general formula (I), preferably R²⁴ is, for example, cyclo(C₅-C₇)alkyl optionally having suitable substituent, such as the following.

(a) 3,4-dioxocyclohexyl

(b) 3-R²⁰-4-R²¹-cyclohexyl,

wherein R²⁰ is hydroxy, alkyloxy or —OCH₂OCH₂CH₂OCH₃, and R²¹ is hydroxy, —OCN, alkyloxy, heteroaryloxy having suitable substituent, —OCH₂OCH₂CH₂OCH₃, protected hydroxy, chloro, bromo, iodo, aminooxalyloxy, azide, p-tolyloxythiocarbonyloxy, or R²⁵R²⁶CHCOO— (wherein R²⁵ is hydroxy optionally protected where desired or protected amino, and R²⁶ is hydrogen atom or methyl, or R²⁰ and R²¹ in combination form an oxygen atom of epoxide ring or

(c) cyclopentyl wherein cyclopentyl is substituted by methoxymethyl, optionally protected hydroxymethyl where desired, acyloxymethyl (wherein acyl moiety is optionally quaternized dimethylamino or optionally esterified carboxy), one or more optionally protected amino and/or hydroxy, or aminooxalyloxymethyl. Preferable examples include 2-formyl-cyclopentyl.

The definition of each symbol used in the formula (I), specific examples thereof and preferable embodiments thereof will be explained in detail in the following.

“Lower” generally means a group having from about 1 to about 6 carbon atoms unless otherwise indicated.

Preferable examples of the alkyl moiety of “alkyl” and “alkyloxy” include linear or branched fatty hydrocarbon residue, such as lower alkyl (e.g., methyl, ethyl, propyl, isopropyl, butyl, isobutyl, pentyl, neopentyl, hexyl and the like).

Preferable examples of “alkenyl” include linear or branched fatty hydrocarbon residue having one double bond, such as lower alkenyl (e.g., vinyl, propenyl (e.g., allyl and the like), butenyl, methylpropenyl, pentenyl, hexenyl and the like).

Preferable examples of “aryl” include phenyl, tolyl, xylyl, cumenyl, mesityl, naphthyl and the like.

Preferable examples of the protective group for “protected hydroxy” and “protected amino” include 1-(loweralkylthio)(lower)alkyl such as lower alkylthiomethyl (e.g., methylthiomethyl, ethylthiomethyl, propylthiomethyl, isopropylthiomethyl, butylthiomethyl, isobutylthiomethyl, hexylthiomethyl and the like), with more preference given to C₁-C₄ alkylthiomethyl and most preference given to methylthiomethyl; tri-substituted silyl such as tri(lower)alkylsilyl (e.g., trimethylsilyl, triethylsilyl, tributylsilyl, tert-butyl dimethylsilyl, tri-tert-butylsilyl and the like), and lower alkyldiarylsilyl (e.g., methyldiphenylsilyl, ethyldiphenylsilyl, propyldiphenylsilyl, tert-butyldiphenylsilyl and the like), with more preference given to tri(C₁-C₄)alkylsilyl and C₁-C₄ alkyldiphenylsilyl, and most preference given to tert-butyl-dimethylsilyl and tert-butyldiphenylsilyl; acyl such as aliphatic acyl, aromatic acyl and aliphatic acyl substituted by aromatic group, which are derived from carboxylic acid, sulfonic acid and carbamic acid; and the like.

The aliphatic acyl is exemplified by lower alkanoyl optionally having one or more suitable substituent(s) (e.g., carboxy) such as formyl, acetyl, propionyl, butyryl, isobutyryl, valeryl, isovaleryl, pivaloyl, hexanoyl, carboxyacetyl, carboxypropionyl, carboxybutyryl, carboxyhexanoyl and the like; cyclo(lower)alkyloxy(lower)alkanoyl optionally having one or more suitable substituent(s) (e.g., lower alkyl) such as cyclopropyloxyacetyl, cyclobutyloxypropionyl, cycloheptyloxybutyryl, mentyloxyacetyl, mentyloxypropionyl, mentyloxybutyryl, mentyloxypentanoyl, mentyloxyhexanoyl and the like; camphorsulfonyl; lower alkylcarbamoyl having one or more suitable substituent(s) such as carboxy or protected carboxy and the like, such as carboxy(lower)alkylcarbamoyl (e.g., carboxymethylcarbamoyl, carboxyethylcarbamoyl, carboxypropylcarbamoyl, carboxybutylcarbamoyl, carboxypentylcarbamoyl, carboxyhexylcarbamoyl) and tri(lower)alkylsilyl(lower)alkyloxycarbonyl(lower)alkylcarbamoyl (e.g., trimethylsilylmethoxycarbonylethylcarbamoyl, trimethylsilylethoxycarbonylpropylcarbamoyl, triethylsilylethoxycarbonylpropylcarbamoyl, tert-butyl dimethylsilylethoxycarbonylpropylcarbamoyl, trimethylsilylpropoxycarbonylbutylcarbamoyl.

Aromatic acyl is exemplified by aroyl optionally having one or more suitable substituent(s) (e.g., nitro), such as benzoyl, toluoyl, xyloyl, naphthoyl, nitrobenzoyl, dinitrobenzoyl, nitronaphthoyl and the like and arenesulfonyl optionally having one or more suitable substituent(s) (e.g., halogen), such as benzenesulfonyl, toluenesulfonyl, xylenesulfonyl, naphthalenesulfonyl, fluorobenzenesulfonyl, chlorobenzenesulfonyl, bromobenzenesulfonyl, iodobenzenesulfonyl and the like.

The aliphatic acyl substituted by aromatic group may be, for example, ar(lower)alkanoyl optionally having one or more suitable substituent(s) (e.g., lower alkyloxy or trihalo(lower)alkyl and the like), wherein specific examples are phenylacetyl, phenylpropionyl, phenylbutyryl, 2-trifluoromethyl-2-methoxy-2-phenylacetyl, 2-ethyl-2-trifluoromethyl-2-phenylacetyl, 2-trifluoromethyl-2-propoxy-2-phenylacetyl and the like.

Of the above-mentioned acyl, more preferable acyl includes C₁-C₄ alkanoyl optionally having carboxy, cyclo(C₅-C₆)alkyloxy(C₁-C₄)alkanoyl having two (C₁-C₄)alkyl in the cycloalkyl moiety, camphorsulfonyl, carboxy(C₁-C₄)alkylcarbamoyl, tri(C₁-C₄)alkylsilyl(C₁-C₄)alkyloxycarbonyl(C₁-C₄)alkylcarbamoyl, benzoyl optionally having one or two nitro groups, and benzenesulfonyl having halogen, phenyl(C₁-C₄)alkanoyl having C₁-C₄ alkyloxy and trihalo(C₁-C₄)alkyl. Of these, most preferred are acetyl, carboxypropionyl, mentyloxyacetyl, camphorsulfonyl, benzoyl, nitrobenzoyl, dinitrobenzoyl, iodobenzenesulfonyl, 2-trifluoromethyl-2-methoxy-2-phenylacetyl and the like.

Preferable examples of the “heterocyclic group consisting of saturated or unsaturated 5 or 6-membered ring having nitrogen atom, sulfur atom and/or oxygen atom” are pyrolyl, tetrahydrofuryl and the like.

The “heteroaryl optionally having a suitable substituent moiety” of the “heteroaryloxy optionally having a suitable substituent” is that exemplified for R¹ of the compound of the formula I of EP-A-532,088, with preference given to 1-hydroxyethylindol-5-yl. The disclosure is incorporated hereinto by reference.

The tricyclo compound (I) used in the present invention is described in the publications EP-A-184162, EP-A-323042, EP-A-423714, EP-A-427680, EP-A-465426, EP-A-480623, EP-A-532088, EP-A-532089, EP-A-569337, EP-A-626385, WO89/05303, WO93/05058, WO96/31514, WO91/13889, WO91/19495, WO93/5059 and the like. The disclosures of these publications are incorporated herein by reference.

In particular, the compounds called FR900506 (FK506), FR900520 (Ascomycin), FR900523 and FR900525 are produced by the genus Streptomyces, such as Streptomyces tsukubaensis, No. 9993 (depository National Institute of Advanced Industrial Science and Technology, International Patent Organism Depositary, Central 6, 1-1, Higashi 1-chome, Tsukuba-shi, Ibaraki-ken, Japan (formerly Fermentation Research Institute, Agency of Industrial Science and Technology, the Ministry of International Trade and Industry), date of deposit: Oct. 5, 1984, deposit number FERM BP-927) or Streptomyces hygroscopicus subsp. Yakushimaensis, No. 7238 (depository National Institute of Advanced Industrial Science and Technology, International Patent Organism Depositary, Central 6, 1-1, Higashi 1-chome, Tsukuba-shi, Ibaraki-ken, Japan (formerly Fermentation Research Institute, Agency of Industrial Science and Technology, the Ministry of International Trade and Industry), date of deposit Jan. 12, 1985, deposit number: FERM BP-928 (EP-A-0184162)), and the compound of the following formula, FK506 (generic name: Tacrolimus) is a representative compound.

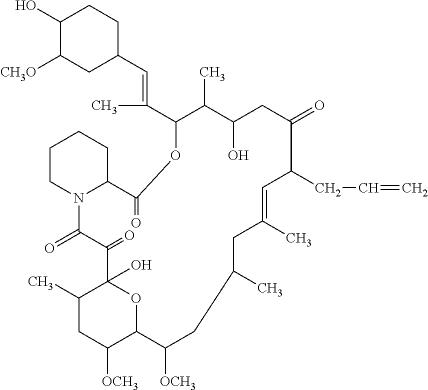

Chemical name: 17-allyl-1,14-dihydroxy-12-[2-(4-hydroxy-3-methoxycyclohexyl)-1-methylvinyl]-23,25-dimethoxy-13,19,21,27-tetramethyl-11,28-dioxa-4-azatricyclo[22.3.1.0^{4,9}]octacos-18-ene-2,3,10,16-tetraone

Of the tricyclo compounds (I), more preferred is a compound wherein adjacent pairs of R³ and R⁴, and R⁵ and R⁶ each independently form another bond optionally between carbon atoms binding with the members of said pairs;

R⁸ and R²³ each independently show hydrogen atom;

R⁹ is hydroxy;

R¹⁰ is methyl, ethyl, propyl or allyl;

X is (hydrogen atom, hydrogen atom) or oxo;

Y is oxo;

R¹⁴, R¹⁵, R¹⁶, R¹⁷, R¹⁸, R¹⁹ and R²² each independently show methyl;

R²⁴ is 3-R²⁰-4-R²¹-cyclohexyl,

wherein R²⁰ is hydroxy, alkyloxy or —OCH₂OCH₂CH₂OCH₃, and R²¹ is hydroxy, —OCN, alkyloxy, heteroaryloxy having suitable substituent, —OCH₂OCH₂CH₂OCH₃, protected hydroxy, chloro, bromo, iodo, aminooxalyloxy, azide, p-tolyloxythiocarbonyloxy or R²⁵R²⁶CHCOO— (wherein R²⁵ is optionally protected hydroxy as desired, or protected amino, and R²⁶ is hydrogen atom or methyl), or R²⁰ and R²¹ in combination form an oxygen atom of epoxide ring; and

n is 1 or 2.

Particularly preferable tricyclo macrolide compounds (I) include, besides FK506, Ascomycin derivatives such as halogenated derivative of 33-epi-chloro-33-desoxy Ascomycin described in Example 66a of EP-A-427,680 and the like.

The pharmaceutically acceptable salt of tricyclo compound and derivatives thereof are nontoxic and pharmaceutically acceptable conventional salts, which are exemplified by salts with inorganic or organic base such as alkali metal salt (e.g., sodium salt, potassium salt and the like), alkaline earth metal salt (e.g., calcium salt, magnesium salt and the like), ammonium salt, and amine salt (e.g., triethylamine salt, N-benzyl-N-methylamine salt and the like).

The tricycle compound of the present invention comprises one or more pairs of stereoisomers, such as optical isomers and geometric isomers, which may be included due to conformers or asymmetric carbon atoms and double bonds. Such conformers and isomers are also encompassed in the present invention. In addition, tricyclo compounds can form solvates, which case is also encompassed in the present invention. Preferable solvate is exemplified by hydrates and ethanolates.

### 3) Alkyl Substituted Polylactide Compound

“Alkyl substituted polylactide”, as used herein, refers to a compound structure:

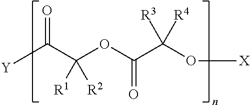

wherein R¹, R², R³, and R⁴ are each independently chosen from the group consisting of alkyl (e.g., unsubstituted alkyl), H, alkenyl and alkylaryl (e.g., unsubstituted alkylaryl); wherein X is hydrogen or, alternatively, has been produced as a result of any further functionalization by chemical reaction on the —OH group formed by the —OX wherein X is hydrogen; Y been derived from any initiator alcohol, or Y is selected from the group consisting of —OH, an alkoxy, benzyloxy and —O—(CH₂—CH₂—O)_{P}—CH₃; and wherein p is 1 to 700, more preferably 1 to 250; and wherein n is an integer from 1 to 500 or more, more preferably 1 to 100, more preferably 1 to 50, more preferably 1 to 25. In certain embodiments, n is from 1 to 12, from 1 to 6, 1, 2, 3, 4, 5, 6, 7, 8, 9, or 10.

In certain embodiments, R¹ and R³ are hydrogen and R² and R⁴ are lower alkyl. For example, R² and R⁴ may be —(CH₂)ₘ—CH₃, wherein m is from 0 to 20, more preferably 0 to 15, more preferably 0 to 10, more preferably m=0 or m=5. In certain embodiments, m is from 0 to 6, 0, 1, 2, 3, 4, 5, 6, 7, 8, 9, 10, 11 or 12.

In certain embodiments an alkyl substituted polylactide may have the following structure:

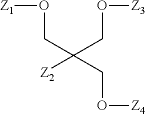

wherein Z₂ is selected from the group consisting of —CH₃ and —CH₂—O—Z₅; and wherein Z₁, Z₃, Z₄, and Z₅, each independently has the structure:

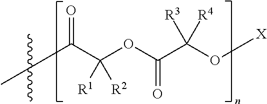

wherein R₁, R₂, R₃, and R₄ are each independently chosen from the group consisting of alkyl (e.g., unsubstituted alkyl), H, alkenyl and alkylaryl (e.g., unsubstituted alkylaryl); wherein n is 1 to 100; wherein X is hydrogen, —C(O)—CH═CH₂ or any other functional or crosslinking group. In certain embodiments, n is 1 to 75, more preferably 1 to 50, more preferably 1 to 25. In certain embodiments, R₁ and R₃ are hydrogen; and R₂ and R₄ are lower alkyl. In certain embodiments, R2 and R4 are —(CH₂)ₘ—CH₃, wherein m is from 0 to 20. In certain embodiments, m is from 0 to 20, more preferably 0 to 15, more preferably 0 to 10, more preferably m=0 or m=5. In certain embodiments, Z₂ is —CH₃; R₁ and R₃ are hydrogen; R₂ and R₄ are —(CH₂)ₘ—CH₃, wherein m is from 0 to 20; and X is hydrogen. In certain embodiments, Z₂ is —CH₃; R₁ and R₃ are hydrogen; R₂ and R₄ are —(CH₂)ₘ—CH₃, wherein m is from 0 to 20; and X is —C(O)—CH═CH₂ or any other functional or crosslinking group. In certain embodiments, Z₂ is —CH₂—O—Z₅; R₁ and R₃ are hydrogen; R₂ and R₄ are —(CH₂)ₘ—CH₃, wherein m is from 0 to 20; and X is hydrogen. In certain embodiments, Z₂ is —CH₂—O—Z₅; R₁ and R₃ are hydrogen; R₂ and R₄ are —(CH₂)ₘ—CH₃, wherein m is from 0 to 20; and X is —C(O)—CH═CH₂. In certain embodiments, m may be from 0 to 20, 0 to 16, 0 to 12, or 0 to 6.

In certain embodiments an alkyl substituted polylactide may have the structure:

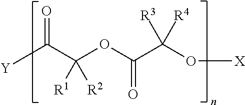

wherein R¹, R², R³, and R⁴ are each independently chosen from the group consisting of alkyl (e.g., unsubstituted alkyl), H, alkenyl and alkylaryl (e.g., unsubstituted alkylaryl); wherein n is 1 to 100; wherein X is hydrogen or —C(O)—CH═CH₂ or any other functional or crosslinking group; and Y is —O—(CH₂—CH₂—O)_{P}—CH₃; wherein p is 1 to 700, more preferably 1 to 250. In certain embodiments, n is 1 to 100, more preferably 1 to 75, more preferably 1 to 50, more preferably 1 to 25, 1 to 12 or 1 to 6. In certain embodiments, R¹ and R³ are hydrogen; and R² and R3 are lower alkyl. In certain embodiments, R² and R⁴ are —(CH₂)ₘ—CH₃, wherein m is from 0 to 20, more preferably 0 to 6. In certain embodiments, m is from 0 to 6, 0, 1, 2, 3, 4, 5, 6, 7, 8, 9, 10, 11, 12.

Alkyl substituted polylactides of the present invention may be synthesized according to the description of WO2007/012979 or WO2012/014011.

As used herein the specification, “a” or “an” may mean one or more. As used herein in the claim(s), when used in conjunction with the word “comprising”, the words “a” or “an” may mean one or more than one. As used herein “another” may mean at least a second or more.

It is contemplated that any embodiment discussed in this specification can be implemented with respect to any method or composition of the invention, and vice versa. Furthermore, compositions of the invention can be used to achieve the methods of the invention.

Throughout this application, the term “about” is used to indicate that a value includes the inherent variation of error for the device, the method being employed to determine the value, or the variation that exists among the study subjects.

The use of the term “or” in the claims is used to mean “and/or” unless explicitly indicated to refer to alternatives only or the alternatives are mutually exclusive.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

An “alkyl” group, as used herein to describe a polylactide, refers to a saturated aliphatic hydrocarbon, including straight-chain, branched chain, and cyclic alkyl groups. Preferably, the alkyl group has 1 to 20 carbons, more preferably 1 to 12 carbons, more preferably 1 to 10. Most preferably, it is a lower alkyl of from 1 to 12 carbons. The alkyl groups of the present invention are preferably unsubstituted. For example, —CH₃, —CH(CH3)₂ and —(CH₂)ₙCH₃, wherein n is 1, 2, 3, 4, 5, 6, 7, 8, 9, 10, 11, 12, 13, 14, 15, 16, 17, 18, 19 or 20 are contemplated alkyl groups that may be used in certain embodiments of the present invention.

An “alkenyl” group, as used herein to describe a polylactide, refers to an unsaturated aliphatic hydrocarbon, including straight-chain, branched chain, and cyclic alkyl groups. Preferably, the alkenyl group has 1 to 20 carbons, more preferably 1 to 12 carbons, more preferably 1 to 10. Most preferably, it is a lower alkenyl of from 1 to 12 carbons.

An “aryl” group, as used herein to describe a polylactide, refers to an unsubstituted aromatic group which has at least one ring having a conjugated pi electron system, and includes carbo cyclic aryl, heterocyclic aryl, and biaryl groups. In certain preferred embodiments, the aryl is an unsubstituted phenyl.

An “alkylaryl” group, as used herein to describe a polylactide, refers to an alkyl (as described above), co valently joined to an aryl group (as described above). Preferably, the alkyl is a lower alkyl. For example, —(CH₂)H(C₆H₅) is contemplated as an alkylaryl, wherein n is 1 to 20.

An “alkoxy” group, as used herein to describe a polylactide, refers to an “—O-alkyl” group, where “alkyl” is defined above.

A “benzyloxy” group, as used herein to describe a polylactide, refers to the group

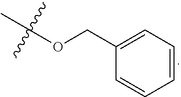 [SMILES: *OCc1ccccc1 ; "."]

“Viscous”, as used herein to describe a polylactide, refers to a polylactide that has a glass transition temperature (Tg) value of less than 44° C. (degree Celsius), more preferably less than 36° C., more preferably less than ° C., more preferably less than 34° C., more preferably less than 33° C., more preferably less than 32° C., more preferably less than 31° C., more preferably less than 30° C., more preferably less than 29° C., more preferably less than 28° C., more preferably less than 27° C., more preferably less than 26° C., more preferably less than 25° C., more preferably less than 24° C., more preferably less than 23° C., more preferably less than 22° C., more preferably less than 21° C., more preferably less than 20° C., more preferably less than 19° C., more preferably less than 18° C., more preferably less than 17° C., more preferably less than 16° C., more preferably less than 15° C., more preferably less than 14° C., more preferably less than 13° C., more preferably less than 12° C., more preferably less than 11° C., more preferably less than 10° C., more preferably less than 9° C., more preferably less than 8° C., more preferably less than 7° C., more preferably less than 6° C., more preferably less than 5° C., more preferably less than 4° C., more preferably less than 3° C., more preferably less than 2° C., more preferably less than 1° C., more preferably less than O° C., more preferably less than −1° C., more preferably less than −2° C., more preferably less than −3° C., more preferably less than −4° C., more preferably less than −5° C., more preferably less than −6° C., more preferably less than −7° C., more preferably less than −8° C., more preferably less than −9° C., most preferably less than −10° C.

The polylactides of the present invention may be used in combination with other polylactides, polyglycolides and their copolymers. For example, the polylactides of the present invention may be admixed with or contacted with a second compound and the resulting composition may be used for drug delivery. Compounds which may be used as the second compound or in combination with the polylactides of the present invention include polyglycolide (PLGA), polylactic acid (PLA), polycaprolactone (PCL), polyethylene glycol (PEG), polydioxanone (PDO), poly(D,L-lactide-co-glycolide) and poly(L-lactide-co-glycolide), poly(hydroxyl alkanoate) (PHA), and biodegradable and biocompatible polymers. Biocompatible polymers include polyester, polyether, polyanhydride, polyamines, poly(ethylene imines) polyamides, polyesteramides, polyorthoesters, polydioxanones, polyacetals, polyketals, polycarbonates, polyphosphoesters, polybutylene, polyterephthalate, polyorthocarbonates, polyphosphazenes, polyurethanes, polytetrafluorethylenes (PTFE), polysuccinates, poly(malic acid), poly(amino acids), polyvinylpyrrolidone, polyhydroxycellulose, polysaccharides, chitin, chitosan, hyaluronic acid, and copolymers, terpolymers and mixtures thereof. In certain embodiments, synthetic polymers and/or natural polymers may be used as the second compound or in combination with polylactides of the present invention. Details are referred in WO2007/012979.

In certain embodiments it may be desirable to contact or admix an alkyl substituted polylactide with one or more pasticizers, in order to alter the physical properties (e.g., lowering the Tg) of the resulting composition. Plasticizers which may be used in combination with an alkyl substituted polylactide include all FDA approved plasticizers, such as benzyl benzoates, cellulose acetates, cellulose acetate phthalates, chlorobutanol, dextrines, dibutyl sebacate, dimethyl sebacate, acetyl phthalates, diethyl phthalate dibutyl phthalate, dipropyl phthalate, dimethyl phthalate, dioctyl phthalate, methyl cellulose, ethyl cellulose, hydroxylethyl cellulose, hydroxypropyl cellulose, hydroxypropyl methyl celluloses, gelatine, glycerines, glyceryl monostearate, monoglycerides, mono and di-acetylated monoglycerides, glycerol, mannitol, mineral oils and lanolin alcohols, petrolatum and lanolin alcohols, castor oil, vegetable oils, coconut oil, polyethylene glycol, polymethacrylates and copolymers thereof, polyvinyl-pyrrolidone, propylene carbonates, propylene glycol, sorbitol, suppository bases, diacetine, triacetin, triethanolamine, esters of citric acid, triethyl citrate, acetyl triethyl citrate, acetyl tributyl citrate, triethyl citrate, esters of phosphoric acid.

For example, certain alkyl substituted polylactides of the present invention (e.g., polylactides with higher molecular weights) may be waxy and thus not injectable. However, these alkyl substituted polylactides may still retain the very desirable property of being very hydrophobic in comparison to normal PLA/PLGA, thus having an advantage for many pharmaceutical applications. An increased hydrophobic drug incorporation into the alkyl substituted polylactide due to the increased hydrophobicity of the polylactide. Certain alkyl substituted polylactides of the present invention (e.g., polylactides with higher molecular weights) may exhibit better control of drug release. Thus, in certain embodiments a non-injectable alkyl substituted polylactide could be made injectable by admixing a plasticizer with the polylactide.

### 4) Pharmaceutical Preparations

Pharmaceutical compositions of the present invention comprise a conjugate comprising a tricyclo compound and an alkyl substituted polylactide compound. Further it is recognized that one or more alkyl substituted polylactide may be used in combination with an additional agent in or as a pharmaceutically acceptable carrier.

The phrases “pharmaceutical or pharmacologically acceptable” refers to molecular entities and compositions that do not produce an adverse, allergic or other untoward reaction when administered to an animal, such as, for example, a human, as appropriate. The preparation of an pharmaceutical composition that contains at least one alkyl substituted polylactide or additional active ingredient will be known to those of skill in the art in light of the present disclosure, as exemplified by Remington's Pharmaceutical Sciences, 18th Ed. Mack Printing Company, 1990, incorporated herein by reference. Moreover, for animal (e.g., human) administration, it will be understood that preparations should meet sterility, pyrogenicity, general safety and purity standards as required by FDA Office of Biological Standards.

As used herein, “pharmaceutically acceptable carrier” includes any and all solvents, dispersion media, coatings, surfactants, antioxidants, preservatives (e.g., antibacterial agents, antifungal agents), isotonic agents, absorption delaying agents, salts, preservatives, drugs, drug stabilizers, gels, binders, excipients, disintegration agents, lubricants, sweetening agents, flavoring agents, dyes, such like materials and combinations thereof, as would be known to one of ordinary skill in the art (see, for example, Remington's Pharmaceutical Sciences, 18th Ed. Mack Printing Company, 1990, pp. 1289-1329, incorporated herein by reference). Except insofar as any conventional carrier is incompatible with the active ingredient, its use in the pharmaceutical compositions is contemplated.

The alkyl substituted polylactide may comprise different types of carriers depending on whether it is to be administered in solid, liquid or aerosol form, and whether it need to be sterile for such routes of administration as injection. The present invention can be administered intravenously, intradermally, transdermally, intrathecally, intraarterially, intraperitoneally, intranasally, intravaginally, intrarectally, topically, intramuscularly, subcutaneously, mucosally, orally, topically, locally, inhalation (e.g., aerosol inhalation), injection, infusion, continuous infusion, localized perfusion bathing target cells directly, via a catheter, via a lavage, in cremes, in lipid compositions (e.g., liposomes), or by other method or any combination of the forgoing as would be known to one of ordinary skill in the art (see, for example, Remington's Pharmaceutical Sciences, 18th Ed. Mack Printing Company, 1990, incorporated herein by reference).

The alkyl substituted polylactide may be formulated into a composition in a free base, neutral or salt form. Pharmaceutically acceptable salts, include the acid addition salts, e.g., those formed with the free amino groups of a proteinaceous composition, or which are formed with inorganic acids such as for example, hydrochloric or phosphoric acids, or such organic acids as acetic, oxalic, tartaric or mandelic acid. Salts formed with the free carboxyl groups can also be derived from inorganic bases such as for example, sodium, potassium, ammonium, calcium or ferric hydroxides; or such organic bases as isopropylamine, trimethylamine, histidine or procaine. Upon formulation, solutions will be administered in a manner compatible with the dosage formulation and in such amount as is therapeutically effective. The formulations are easily administered in a variety of dosage forms such as formulated for parenteral administrations such as injectable solutions, or aerosols for delivery to the lungs, or formulated for alimentary administrations such as drug release capsules and the like.

Further in accordance with the present invention, the composition of the present invention suitable for administration is provided in a pharmaceutically acceptable carrier with or without an inert diluent. The carrier should be assimilable and includes liquid, semi-solid, i.e., pastes, or solid carriers. Except insofar as any conventional media, agent, diluent or carrier is detrimental to the recipient or to the therapeutic effectiveness of the composition contained therein, its use in administrable composition for use in practicing the methods of the present invention is appropriate. Examples of carriers or diluents include fats, oils, water, saline solutions, lipids, liposomes, resins, binders, fillers and the like, or combinations thereof. The composition may also comprise various antioxidants to retard oxidation of one or more component. Additionally, the prevention of the action of microorganisms can be brought about by preservatives such as various antibacterial and antifungal agents, including but not limited to parabens {e.g., methylparabens, propylparabens), chlorobutanol, phenol, sorbic acid, thimerosal or combinations thereof.

In accordance with the present invention, the composition is combined with the carrier in any convenient and practical manner, i.e., by solution, suspension, emulsification, admixture, encapsulation, absorption and the like. Such procedures are routine for those skilled in the art.

In a specific embodiment of the present invention, the composition is combined or mixed thoroughly with a semi-solid or solid carrier. The mixing can be carried out in any convenient manner such as grinding. Stabilizing agents can be also added in the mixing process in order to protect the composition from loss of therapeutic activity, i.e., denaturation in the stomach. Examples of stabilizers for use in an the composition include buffers, amino acids such as glycine and lysine, carbohydrates such as dextrose, mannose, galactose, fructose, lactose, sucrose, maltose, sorbitol, mannitol, etc.

In further embodiments, the present invention may concern the use of a pharmaceutical lipid vehicle compositions that include alkyl substituted polylactide, one or more lipids, and an aqueous solvent. As used herein, the term “lipid” will be defined to include any of a broad range of substances that is characteristically insoluble in water and extractable with an organic solvent. This broad class of compounds are well known to those of skill in the art, and as the term “lipid” is used herein, it is not limited to any particular structure. Examples include compounds which contain long-chain aliphatic hydrocarbons and their derivatives. A lipid may be naturally occurring or synthetic (i.e., designed or produced by man). However, a lipid is usually a biological substance. Biological lipids are well known in the art, and include for example, neutral fats, phospholipids, phosphoglycerides, steroids, terpenes, lysolipids, glycosphingolipids, glycolipids, sulphatides, lipids with ether and ester-linked fatty acids and polymerizable lipids, and combinations thereof. Of course, compounds other than those specifically described herein that are understood by one of skill in the, art as lipids are also encompassed by the compositions and methods of the present invention.

One of ordinary skill in the art would be familiar with the range of techniques that can be employed for dispersing a composition in a lipid vehicle. For example, the alkyl substituted polylactide may be dispersed in a solution containing a lipid, dissolved with a lipid, emulsified with a lipid, mixed with a lipid, combined with a lipid, covalently bonded to a lipid, contained as a suspension in a lipid, contained or complexed with a micelle or liposome, or otherwise associated with a lipid or lipid structure by any means known to those of ordinary skill in the art. The dispersion may or may not result in the formation of liposomes.

The actual dosage amount of a composition of the present invention administered to an animal patient can be determined by physical and physiological factors such as body weight, severity of condition, the type of disease being treated, previous or concurrent therapeutic interventions, idiopathy of the patient and on the route of administration. Depending upon the dosage and the route of administration, the number of administrations of a preferred dosage and/or an effective amount may vary according to the response of the subject. The practitioner responsible for administration will, in any event, determine the concentration of active ingredient(s) in a composition and appropriate dose(s) for the individual subject.

In certain embodiments, pharmaceutical compositions may comprise, for example, at least about 0.1% of an active compound. In other embodiments, the an active compound may comprise between about 2% to about 75% of the weight of the unit, or between about 25% to about 60%, for example, and any range derivable therein. Naturally, the amount of active compound(s) in each therapeutically useful composition may be prepared is such a way that a suitable dosage will be obtained in any given unit dose of the compound. Factors such as solubility, bioavailability, biological half-life, route of administration, product shelf life, as well as other pharmacological considerations will be contemplated by one skilled in the art of preparing such pharmaceutical formulations, and as such, a variety of dosages and treatment regimens may be desirable.

In other non-limiting examples, a dose may also comprise from about 1 microgram/kg/body weight, about 5 microgram/kg/body weight, about 10 microgram/kg/body weight, about 50 microgram/kg/body weight, about 100 microgram/kg/body weight, about 200 microgram/kg/body weight, about 350 microgram/kg/body weight, about 500 microgram/kg/body weight, about 1 milligram/kg/body weight, about 5 milligram/kg/body weight, about 10 milligram/kg/body weight, about 50 milligram/kg/body weight, about 100 milligram/kg/body weight, about 200 milligram/kg/body weight, about 350 milligram/kg/body weight, about 500 milligram/kg/body weight, to about 1000 mg/kg/body weight or more per administration, and any range derivable therein. In non-limiting examples of a derivable range from the numbers listed herein, a range of about 5 mg/kg/body weight to about 100 mg/kg/body weight, about 5 microgram/kg/body weight to about 500 milligram/kg/body weight, etc., can be administered, based on the numbers described above.

### A. Ophthalmic Compositions and Formulations

In preferred embodiments of the present invention, the conjugates are formulated to be administered topically to the eyes of the patient. The ophthalmic composition of the present invention includes any dosage form for ocular topical administration used in the field of ophthalmology, such as an ophthalmic solution, an eye drop and an eye ointment. The ophthalmic composition can be prepared in accordance with conventional means known in the relevant technical field.

The ophthalmic solution or eye drop is prepared by dissolving an active ingredient in a solvent such as an aqueous sterilization solution (for example, brine and buffer solution), or mixing with a powder composition which is dissolved at the time of use. The eye ointment is prepared by mixing an active ingredient with a base.

An “osmotic agent” may added to the ophthalmic composition. The osmotic agent or equivalently an osmoregulating chemical may be any one used usually in the ophthalmology field. Examples of the osmoregulating chemical include, but are not limited to, sodium chloride, potassium chloride, calcium chloride, sodium hydrogen carbonate, sodium carbonate, magnesium sulfate, sodium hydrogen phosphate, sodium dihydrogen phosphate, potassium dihydrogen phosphate, boric acid, borax, sodium hydroxide, hydrochloric acid, mannitol, sorbitol, glucose, glycerin, propylene glycol, polyethylene glycol and the like. The osmoregulating chemical is preferably a sugar alcohol such as mannitol or sorbitol and/or a polyol such as glycerin or propylene glycol.

In the present invention, in order to improve solubility of the tricyclo compound in the solvent, a solubilizing agent such as a surfactant can be used. The surfactant used in the present invention is not limited as long as it can achieve the object, and a nonionic surfactant is preferred. Examples of the nonionic surfactant include polyoxyethylene sorbitan fatty acid esters such as polyoxyethylene sorbitan monooleate (Polysorbate 80), polyoxyethylene sorbitan monostearate (Polysorbate 60), polyoxyethylene sorbitan monopalmitate (Polysorbate 40), polyoxyethylene sorbitan monolaurate, polyoxyethylene sorbitan trioleate and polyoxyethylene sorbitan tristearate (Polysorbate 65); polyoxyethylene hardened castor oils such as polyoxyethylene hardened castor oil 10, polyoxyethylene hardened castor oil 40, polyoxyethylene hardened castor oil 50 and polyoxyethylene hardened castor oil 60; polyoxyethylene polyoxypropylene glycols such as polyoxyethylene (160) polyoxypropylene (30) glycol [Pluronic F68] and polyoxyethylene (42) polyoxypropylene (67) glycol [Pluronic P123]; polyoxyethylene fatty acid esters such as polyoxyethylene 40 monostearate; and polyoxyethylene alkyl ethers such as polyoxy 10 oleyl ether (Brij 97) and polyoxyl 20 oleyl ether (Brij 98). Preferably, polyoxyethylene sorbitan monooleate (Polysorbate 80), polyoxyethylene hardened castor oil 60, polyoxyethylene 40 monostearate, polyoxyl 10 oleyl ether and the like are exemplified, and these nonionic surfactants may be used alone, or two or more kinds of them may be used in combination.

Furthermore, additive used usually in the field of ophthalmology may be optionally added to the composition of the present invention. Examples of the additive include buffers (for example, boric acid, borax, sodium hydrogen phosphate and sodium dehydrogen phosphate, sodium edetate), preservatives (for example, benzalkonium chloride, benzethonium chloride and chlorobutanol), thickeners (for example, polysaccharides such as sodium hyaluronate, chondroitin sulfate, guar gum, gellan gum, xantan gum and sodium alginate; cellulose polymers such as methyl cellulose, methyl ethyl cellulose and hydroxypropyl methyl cellulose; sodium polyacrylate, a carboxyvinyl polymer and a crosslinked polyacrylic acid.

In the preparation of the eye ointment, the composition may contain, in addition to the above additives, commonly used eye ointment bases. Examples of the eye ointment bases include, but are not limited to, oily bases such as petrolatum, liquid paraffin, polyethylene, Selene 50, Plastibase, macrogol or a combination thereof; emulsion bases containing an oil phase and an aqueous phase emulsified by the surfactant; and water-soluble bases such as hydroxypropyl methyl cellulose, carboxypropyl methyl cellulose and polyethylene glycol.

The term “dosage unit form” and “dosage form” as used herein refer to a single entity for drug administration. In one embodiment, the composition of the present invention may be formulated as a sterile unit dose containing no preservative or substantially free of preservative. The unit dosage form may be administered at one, two, three, four, or more times per day. When ocular local administration is used, one, two, three, four, or more drops may be administered at each time. In one embodiment, the ophthalmic solution is administered at least three drops per day. In another embodiment, the ophthalmic solution is administered at least four drops per day. In another embodiment, the ophthalmic solution is administered at least two drops per time, twice a day. In yet another embodiment, the ophthalmic solution is administered at least two drops per time with at least a five minute interval between drops, twice a day.

In one embodiment, the composition is administered by injection, ophthalmic pump, by means of a contact lens, a cellulose lens, a micropump, a conjunctival pump, an implantable device, a gel capsule, a patch, etc.

The concentration of the tricyclo compound used in the present invention varies depending on the compounds used, kinds of subjects, age, body weight, symptoms to be treated, desired therapeutic effect, dose, treatment duration and the like, and appropriately proper concentration can be selected.

As used herein, “ocular locally administering” includes administration via eye drop, periocular (e.g., subTenon's), subconjunctival, intraocular, subretinal, suprachoroidal and retrobulbar administrations. Ocular local administration may also be administered topically using, for example, an ophthalmic ointment, a gel, a patch, injection, or by means of a contact lens, a cellulose lens, an ophthalmic pump, a micropump, a conjunctival pump, an injector, or an implantable device.

In the present invention, in the case of using Tacrolimus, the concentration of the compound is 0.01 w/v % or more, preferably 0.06 w/v % or more, and more preferably 0.1 w/v % or more. The upper limit of the concentration is not particularly restrictive and may be set at approximately 10 w/v %.

### B. Alimentary Compositions and Formulations

In preferred embodiments of the present invention, the alkyl substituted polylactide are formulated to be administered via an alimentary route. Alimentary routes include all possible routes of administration in which the composition is in direct contact with the alimentary tract. Specifically, the pharmaceutical compositions disclosed herein may be administered orally, buccally, rectally, or sublingually. As such, these compositions may be formulated with an inert diluent or with an assimilable edible carrier, or they may be enclosed in hard- or soft-shell gelatin capsule, or they may be compressed into tablets, or they may be incorporated directly with the food of the diet. In certain embodiments, the active compounds may be incorporated with excipients and used in the form of ingestible tablets, buccal tables, troches, capsules, elixirs, suspensions, syrups, wafers, and the like (Mathiowitz et at, 1997; Hwang et at, 1998; U.S. Pat. Nos. 5,641,515; 5,580,579 and 5,792,451, each specifically incorporated herein by reference in its entirety). The tablets, troches, pills, capsules and the like may also contain the following: a binder, such as, for example, gum tragacanth, acacia, cornstarch, gelatin or combinations thereof; an excipient, such as, for example, dicalcium phosphate, mannitol, lactose, starch, magnesium stearate, sodium saccharine, cellulose, magnesium carbonate or combinations thereof; a disintegrating agent, such as, for example, corn starch, potato starch, alginic acid or combinations thereof; a lubricant, such as, for example, magnesium stearate; a sweetening agent, such as, for example, sucrose, lactose, saccharin or combinations thereof; a flavoring agent, such as, for example peppermint, oil of wintergreen, cherry flavoring, orange flavoring, etc. When the dosage unit form is a capsule, it may contain, in addition to materials of the above type, a liquid carrier. Various other materials may be present as coatings or to otherwise modify the physical form of the dosage unit. For instance, tablets, pills, or capsules may be coated with shellac, sugar, or both. When the dosage form is a capsule, it may contain, in addition to materials of the above type, carriers such as a liquid carrier. Gelatin capsules, tablets, or pills may be enterically coated. Enteric coatings prevent denaturation of the composition in the stomach or upper bowel where the pH is acidic. See, e.g., U.S. Pat. No. 5,629,001. Upon reaching the small intestines, the basic pH therein dissolves the coating and permits the composition to be released and absorbed by specialized cells, e.g., epithelial enterocytes and Peyer's patch M cells. A syrup of elixir may contain the active compound sucrose as a sweetening agent methyl and propylparabens as preservatives, a dye and flavoring, such as cherry or orange flavor. Of course, any material used in preparing any dosage unit form should be pharmaceutically pure and substantially non-toxic in the amounts employed. In addition, the active compounds may be incorporated into sustained-release preparation and formulations.

For oral administration the compositions of the present invention may alternatively be incorporated with one or more excipients in the form of a mouthwash, dentifrice, buccal tablet, oral spray, or sublingual orally-administered formulation. For example, a mouthwash may be prepared incorporating the active ingredient in the required amount in an appropriate solvent, such as a sodium borate solution (Dobell's Solution). Alternatively, the active ingredient may be incorporated into an oral solution such as one containing sodium borate, glycerin and potassium bicarbonate, or dispersed in a dentifrice, or added in a therapeutically-effective amount to a composition that may include water, binders, abrasives, flavoring agents, foaming agents, and humectants. Alternatively the compositions may be fashioned into a tablet or solution form that may be placed under the tongue or otherwise dissolved in the mouth.

Additional formulations which are suitable for other modes of alimentary administration include suppositories. Suppositories are solid dosage forms of various weights and shapes, usually medicated, for insertion into the rectum. After insertion, suppositories soften, melt or dissolve in the cavity fluids. In general, for suppositories, traditional carriers may include, for example, polyalkylene glycols, triglycerides or combinations thereof. In certain embodiments, suppositories may be formed from mixtures containing, for example, the active ingredient in the range of about 0.5% to about 10%, and preferably about 1% to about 2%.

### C. Parenteral Compositions and Formulations

In further embodiments, an alkyl substituted polylactide may be administered via a parenteral route. As used herein, the term “parenteral” includes routes that bypass the alimentary tract. Specifically, the pharmaceutical compositions disclosed herein may be administered for example, but not limited to intravenously, intradermally, intramuscularly, intraarterially, intrathecally, subcutaneous, or intraperitoneally U.S. Pat. Nos. 6,753,514, 6,613,308, 5,466,468, 5,543,158; 5,641,515; and 5,399,363 (each specifically incorporated herein by reference in its entirety).

Solutions of the active compounds as free base or pharmacologically acceptable salts may be prepared in water suitably mixed with a surfactant, such as hydroxypropylcellulose. Dispersions may also be prepared in glycerol, liquid polyethylene glycols, and mixtures thereof and in oils. Under ordinary conditions of storage and use, these preparations contain a preservative to prevent the growth of microorganisms. The pharmaceutical forms suitable for injectable use include sterile aqueous solutions or dispersions and sterile powders for the extemporaneous preparation of sterile injectable solutions or dispersions (U.S. Pat. No. 5,466,468, specifically incorporated herein by reference in its entirety). In all cases the form must be sterile and must be fluid to the extent that easy injectability exists. It must be stable under the conditions of manufacture and storage and must be preserved against the contaminating action of microorganisms, such as bacteria and fungi. The carrier can be a solvent or dispersion medium containing, for example, water, ethanol, polyol (i.e., glycerol, propylene glycol, and liquid polyethylene glycol, and the like), suitable mixtures thereof, and/or vegetable oils. Proper fluidity may be maintained, for example, by the use of a coating, such as lecithin, by the maintenance of the required particle size in the case of dispersion and by the use of surfactants. The prevention of the action of microorganisms can be brought about by various antibacterial and antifungal agents, for example, parabens, chlorobutanol, phenol, sorbic acid, thimerosal, and the like. In many cases, it will be preferable to include isotonic agents, for example, sugars or sodium chloride. Prolonged absorption of the injectable compositions can be brought about by the use in the compositions of agents delaying absorption, for example, aluminum monostearate and gelatin.

For parenteral administration in an aqueous solution, for example, the solution should be suitably buffered if necessary and the liquid diluent first rendered isotonic with sufficient saline or glucose. These particular aqueous solutions are especially suitable for intravenous, intramuscular, subcutaneous, and intraperitoneal administration. In this connection, sterile aqueous media that can be employed will be known to those of skill in the art in light of the present disclosure. For example, one dosage may be dissolved in 1 ml of isotonic NaCl solution and either added to 1000 ml of hypodermoclysis fluid or injected at the proposed site of infusion, (see for example, “Remington's Pharmaceutical Sciences” 15th Edition, pages 1035-1038 and 1570-1580). Some variation in dosage will necessarily occur depending on the condition of the subject being treated. The person responsible for administration will, in any event, determine the appropriate dose for the individual subject. Moreover, for human administration, preparations should meet sterility, pyrogenicity, general safety and purity standards as required by FDA Office of Biologies standards.

Sterile injectable solutions are prepared by incorporating the active compounds in the required amount in the appropriate solvent with various of the other ingredients enumerated above, as required, followed by filtered sterilization. Generally, dispersions are prepared by incorporating the various sterilized active ingredients into a sterile vehicle which contains the basic dispersion medium and the required other ingredients from those enumerated above. In the case of sterile powders for the preparation of sterile injectable solutions, the preferred methods of preparation are vacuum-drying and freeze-drying techniques which yield a powder of the active ingredient plus any additional desired ingredient from a previously sterile-filtered solution thereof. A powdered composition is combined with a liquid carrier such as, e.g., water or a saline solution, with or without a stabilizing agent.

### D. Miscellaneous Pharmaceutical Compositions and Formulations

In other preferred embodiments of the invention, the active compound alkyl substituted polylactide may be formulated for administration via various miscellaneous routes, for example, topical {i.e., transdermal) administration, mucosal administration (intranasal, vaginal, etc.) and/or inhalation.

Pharmaceutical compositions for topical administration may include the active compound formulated for a medicated application such as an ointment, paste, cream or powder. Ointments include all oleaginous, adsorption, emulsion and water-solubly based compositions for topical application, while creams and lotions are those compositions that include an emulsion base only. Topically administered medications may contain a penetration enhancer to facilitate adsorption of the active ingredients through the skin. Suitable penetration enhancers include glycerin, alcohols, alkyl methyl sulfoxides, pyrrolidones and luarocapram. Possible bases for compositions for topical application include polyethylene glycol, lanolin, cold cream and petrolatum as well as any other suitable absorption, emulsion or water-soluble ointment base. Topical preparations may also include emulsifiers, gelling agents, and antimicrobial preservatives as necessary to preserve the active ingredient and provide for a homogenous mixture. Transdermal administration of the present invention may also comprise the use of a “patch”. For example, the patch may supply one or more active substances at a predetermined rate and in a continuous manner over a fixed period of time.

In certain embodiments, the pharmaceutical compositions may be delivered by eye drops, intranasal sprays, inhalation, and/or other aerosol delivery vehicles. Methods for delivering compositions directly to the lungs via nasal aerosol sprays has been described e.g., in U.S. Pat. Nos. 5,756,353 and 5,804,212 (each specifically incorporated herein by reference in its entirety). Likewise, the delivery of drugs using intranasal microparticle resins (Takenaga et al, 1998) and lysophosphatidyl-glycerol compounds (U.S. Pat. No. 5,725,871, specifically incorporated herein by reference in its entirety) are also well-known in the pharmaceutical arts. Likewise, transmucosal drug delivery in the form of a polytetrafluoroethylene support matrix is described in U.S. Pat. No. 5,780,045 (specifically incorporated herein by reference in its entirety). The term aerosol refers to a colloidal system of finely divided solid of liquid particles dispersed in a liquefied or pressurized gas propellant. The typical aerosol of the present invention for inhalation will consist of a suspension of active ingredients in liquid propellant or a mixture of liquid propellant and a suitable solvent. Suitable propellants include hydrocarbons and hydrocarbon ethers. Suitable containers will vary according to the pressure requirements of the propellant. Administration of the aerosol will vary according to subject's age, weight and the severity and response of the symptoms.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example

### 1 Introduction

Objective is the evaluation of the methoxypoly(ethylene glycol)-hexyl-substituted poly(lactic acid) [MPEG-hexPLA] polymer micelles' potential to incorporate and solubilize Tacrolimus.

### 2 Studies

The incorporation studies were carried out by a standard formulation protocol. Briefly, a defined amount of Tacrolimus was dissolved in acetone and added dropwise under sonication into water, followed by evaporation of the organic solvent and equilibration of the micelle solution overnight.

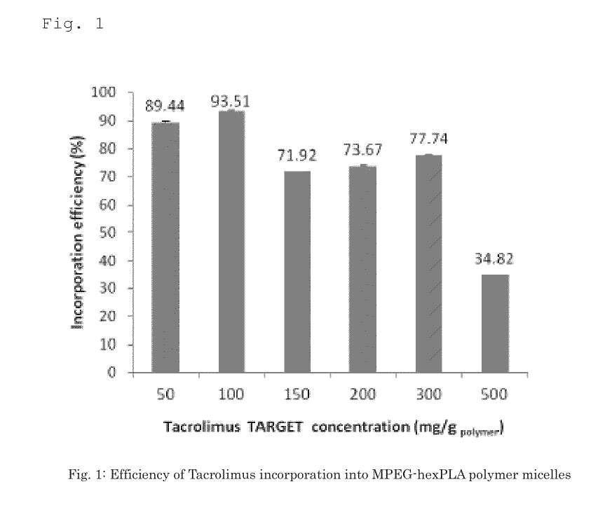

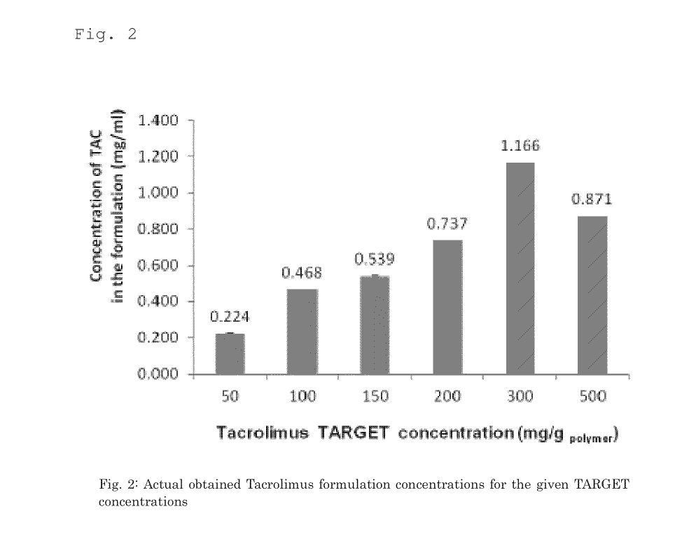

The results of the incorporation studies with increasing targeted drug loadings are summarized in the following FIGS. 1 and 2. As it can be seen, for loadings up to 300 mg Tacrolimus per gram MPEGhexPLA, loading efficiencies higher than 70% could be obtained by this simple procedure. FIG. 2 presents the corresponding concentrations of Tacrolimus in the aqueous solution. It has to be noted, that these solutions can be further concentrated by simple evaporation to obtain higher drug concentrations, and keeping the transparency of the solutions.

### 3 Observations

While storing these formulations at 4° C. it was observed that the best stable formulation was the one with a target of 150 mg/g. For higher and possibly oversaturated Tacrolimus formulations a slight drug precipitation occurred. The non-incorporated active compound can be removed by a simple filtration.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A conjugate comprising a tricyclo compound and an alkyl substituted polylactide compound.

2. The conjugate of claim 1, the tricyclo compound is represented by the formula (I) or a pharmaceutically acceptable salt thereof: 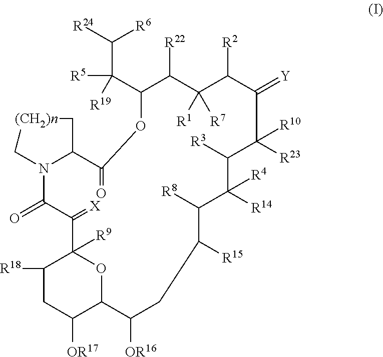
wherein adjacent pairs of R¹ and R², R³ and R⁴, and R⁵ and R⁶ each independently
a) consist of two adjacent hydrogen atoms, wherein R² is optionally alkyl, or
b) form another bond optionally between carbon atoms binding with the members of said pairs;
R⁷ is hydrogen atom, hydroxy, protected hydroxy or alkyloxy, or may form oxo with R¹;
R⁸ and R⁹ each independently show hydrogen atom or hydroxy;
R¹⁰ is hydrogen atom, alkyl, alkyl substituted by one or more hydroxy, alkenyl, alkenyl substituted by one or more hydroxy or alkyl substituted by oxo;
X is oxo, (hydrogen atom, hydroxy), (hydrogen atom, hydrogen atom), or a group of the formula —CH₂O—;
Y is oxo, (hydrogen atom, hydroxy), (hydrogen atom, hydrogen atom), or a group of the formula N—NR¹¹R¹² or N—OR¹³;
R¹¹ and R¹² each independently show hydrogen atom, alkyl, aryl or tosyl;
R¹³, R¹⁴, R¹⁵, R¹⁶, R¹⁷, R¹⁸, R¹⁹, R²² and R²³ each independently show hydrogen atom or alkyl;
R²⁴ is an optionally substituted ring that may contain one or more hetero atom(s); and
n is 1 or 2.

3. The conjugate of claim 2, wherein the tricycle compound is the following structure:

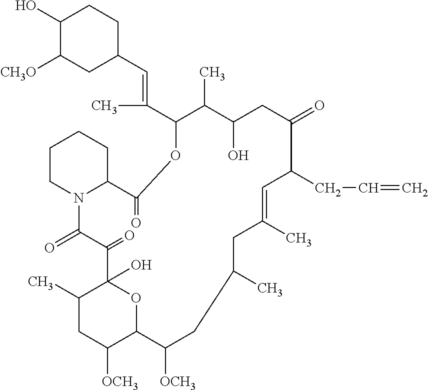

4. The conjugate of claim 1, wherein the alkyl substituted polylactide compound is having the structure: 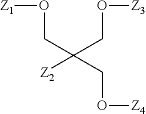
wherein Z₂ is selected from the group consisting of —CH₃ and —CH₂—O—Z₅; and wherein Z₁, Z₃, Z₄, and Z₅, each independently has the structure: 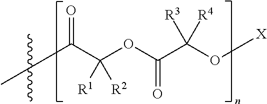
wherein R₁, R₂, R₃, and R₄ are each independently chosen from the group consisting of alkyl, H alkenyl and alkylaryl; wherein n is 1 to 100; wherein X is hydrogen, —C(O)—CH═CH₂ or any other functional or crosslinking group.

5. The conjugate of claim 4, wherein n is 1 to 75.

6. The conjugate of claim 4, wherein n is 1 to 50.

7. The conjugate of claim 4, wherein R₁ and R₃ are hydrogen; and R₂ and R₄ are lower alkyl.

8. The conjugate of claim 4, wherein R₂ and R₄ are —(CH₂)ₘ—CH₃, wherein m is from 0 to 20.

9. The conjugate of claim 8, wherein m is from 0 to 12.

10. The conjugate of claim 4, wherein Z₂ is —CH₃; R₁ and R₃ are hydrogen; R₂ and R₄ are —(CH₂)ₘ—CH₃, wherein m is from 0 to 20; and X is hydrogen.

11. The conjugate of claim 4, wherein Z₂ is —CH₃; R₁ and R₃ are hydrogen; R₂ and R₄ are —(CH₂)ₘ—CH₃, wherein m is from 0 to 12; and X is —C(O)—CH═CH₂.

12. The conjugate of claim 4, wherein Z₂ is —CH₂—O—Z₅; R₁ and R₃ are hydrogen; R₂ and R₄ are —(CH₂)ₘ—CH₃, wherein m=0 or m=5; and X is hydrogen.

13. The conjugate of claim 4, wherein Z₂ is —CH₂—O—Z₅; R₁ and R₃ are hydrogen; R₂ and R₄ are —(CH₂)ₘ—CH₃, wherein m=0 or m=5; and X is —C(O)—CH═CH₂.

14. The conjugate of claim 1, wherein the alkyl substituted polylactide compound is having the structure: 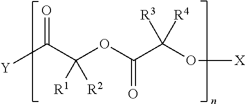
wherein R¹, R², R³, and R⁴ are each independently chosen from the group consisting of alkyl, H, alkenyl and alkylaryl; wherein n is 1 to 100; wherein X is hydrogen or —C(O)—CH═CH₂ or any other functional or crosslinking group; and Y is selected from the group consisting of —OH, an alkoxy, benzyloxy and —O—(CH₂—CH₂—O)_{P}—CH₃; and wherein p is 1 to 700.

15. The conjugate of claim 14, wherein n is 1 to 75.

16. The conjugate of claim 14, wherein n is 1 to 50.

17. The conjugate of claim 14, wherein p is 1 to 250.

18. The conjugate of claim 14, wherein R¹ and R³ are hydrogen; and R² and R⁴ are lower alkyl.

19. The conjugate of claim 14, wherein Y is —O—(CH₂—CH₂—O)_{P}—CH₃.

20. The conjugate of claim 14, wherein R² and R⁴ are —(CH₂)ₘ—CH₃, wherein m is from 0 to 20.

21. The conjugate of claim 20, wherein m is from 0 to 12.

22. The conjugate of claim 1, wherein the conjugate is injectable.

23. The conjugate of claim 1, wherein the conjugate is formulated for parenteral administration.

24. The conjugate of claim 1, wherein the conjugate is formulated for eye local administration.

25. A pharmaceutical composition comprising a conjugate comprising a tricyclo compound and an alkyl substituted polylactide compound.
